(19) United States
(12) Patent Application Publication
(10) Pub. No.: US 2013/0144882 A1
(43) Pub. Date: Jun. 6, 2013

(54) MULTIDIMENSIONAL INTEGRATIVE EXPRESSION PROFILING FOR SAMPLE CLASSIFICATION

(71) Applicant: Medeolinx, LLC, Indianapolis, IN (US)

(72) Inventors: Jake Yue Chen, Indianapolis, IN (US); Xiaogang Wu, Indianapolis, IN (US)

(73) Assignee: Medeolinx, LLC, Indianapolis, IN (US)

(21) Appl. No.: 13/690,208

(22) Filed: Nov. 30, 2012

Related U.S. Application Data
(60) Provisional application No. 61/566,641, filed on Dec. 3, 2011.
(60) Provisional application No. 61/566,642, filed on Dec. 3, 2011.
(60) Provisional application No. 61/566,644, filed on Dec. 3, 2011.

(51) Int. Cl. G06F 17/30

(52) U.S. Cl. CPC G06F 17/30598
USPC 707/738; 707/758; 707/756

(57) ABSTRACT

An organized knowledge-supervised approach—Multidimensional Integrative eXpression Profiling (MIXP)—can not only improve sample classification accuracy by serving as a feature transformation approach, but also help in the discovery of groups of crucial molecular entities that have been too weak to detect individually through preexisting methods. Functionally related molecules that are individually expressed with low differentials, have often been considered as noise and ignored in traditional studies, but through the MIXP approach, they can be readily identified by virtue of their coordinate expression.

### CROSS-REFERENCE TO RELATED APPLICATIONS

The present application claims priority under 35 U.S.C. §119(e) of U.S. Patent Provisional Application Ser. Nos. 61/566,641, 61/566,642, and 61/566,644, respectively titled Multidimensional Integrative Expression Profiling for Sample Classification, Integrative Pathway Modeling for Drug Efficacy Prediction, and Network Modeling for Drug Toxicity Prediction, all filed Dec. 3, 2011, the disclosures of which are incorporated by reference herein.

### BACKGROUND OF THE INVENTION

1. Field of the Invention

The invention relates to molecular profiling based on network modeling and analysis. More specifically, the present disclosure relates to computational methods, systems, devices and/or apparatuses for molecular expression analysis and candidate biomarker discovery.

2. Description of the Related Art

Over 1500 Mendelian conditions whose molecular cause is unknown are listed in the Online Mendelian Inheritance in Man (OMIM) database. Additionally, almost all medical conditions are in some way influenced by human genetic variation. The identification of genes associated with these conditions is a goal of numerous research groups, in order to both improve medical care and better understand gene functions, interactions, and pathways. Sequencing large numbers of candidate genes remains a time-consuming and expensive task, and it is often not possible to identify the correct disease gene by inspection of the list of genes within the interval.

A number of computational approaches toward candidate-gene prioritization have been developed that are based on functional annotation, gene-expression data, or sequence-based features. High-throughput technologies have produced vast amounts of protein-protein interaction data, which represent a valuable resource for candidate-gene prioritization, because genes related to a specific or similar disease phenotype tend to be located in a specific neighborhood in the protein-protein interaction network. However, only relatively simple methods for exploring biological networks have been applied to the problem of candidate-gene prioritization, such as the search for direct neighbors of other disease genes and the calculation of the shortest path between candidates and known disease proteins.

### SUMMARY OF THE INVENTION

The present invention is a computational system and method which allows for the identification and use of iterative weighing of network nodes that integrates disease-associated molecular entities, their expressions, and their molecular interaction networks.

Network-based gene expression analysis has been proposed for candidate biomarker discovery by integrating disease susceptibility genes, gene expressions, and gene/protein interaction networks. Current network-based gene expression analysis methods do reference the interactions among concerned genes or gene products, but they still consider each single gene expression individually, without taking into account the expression values of neighbor genes with similar or related functions in a given network.

The present invention, in one form, relates to an organized knowledge-supervised process—Multidimensional Integrative eXpression Profiling (MIXP)—which may not only improve sample classification accuracy by serving as a feature transformation approach, but also helps in the discovery of groups of crucial molecular entities (e.g., genes, proteins, metabolites, or RNAs) that have been too weak to detect individually through preexisting methods. Functionally related molecules that are individually expressed with low differentials, have often been considered as noise and ignored in traditional studies, but through the MIXP approach, they can be readily identified by virtue of their coordinate expression. To implement MIXP, network analysis algorithms (including network ranking, network clustering, and network reordering) are used to group functionally related genes in an ordered way.

In one embodiment, the present invention relates to a method of creating a database for identifying the occurrence of a particular personal health situation. First, a plurality of related targets relating to a particular disease or condition is identified. A network of related targets is created wherein one of the related targets is expanded to include neighboring targets. The nodes are organized according to an iterative weighing so that nodes with similar reactivity with the particular disease or condition are grouped within the network and trace responses are aggregated according to network proximity to identify relevant targets to the particular disease. The related targets are stored in a data set model on a memory device. The particular health situation involves a disease or a condition. The step of identifying includes identifying genes related to the particular health situation. The creating step includes expanding a plurality of related targets, and after expanded the plurality of related targets are combined. The organizing step involves using a flow simulation algorithm in the iterative weighing. The organizing step involves using an ant colony optimization algorithm in the iterative weighing. The method further includes the step of obtaining a gene-expression profile from a particular patient, and mapping the gene-expression profile from the particular patient onto organized nodes.

In another embodiment, the present invention relates to a method of identifying the propensity of a particular personal health situation for a particular patient. First, a sample is obtained from a patient. A gene expression profile is created for the patient based on the sample. The results of said sample are compared with a database relating to the particular disease, with the database having been created according to the foregoing method.

In another embodiment, the present invention relates to a system for determining the propensity of a particular personal health situation for a particular patient. A patient profile module is configured to generate a gene-expression profile from a sample from the particular patient. A mapping module is configured to map the gene-expression profile onto a database created according to the foregoing method for the particular personal health situation. A calculation module is configured to integrate influence functions of the gene-expression profile and provide an indication of the particular personal health situation propensity of the particular patient.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a schematic diagrammatic view of a network system in which embodiments of the present invention may be utilized.

FIG. 2 is a block diagram of a computing system (either a server or client, or both, as appropriate), with optional input devices (e.g., keyboard, mouse, touch screen, etc.) and output devices, hardware, network connections, one or more processors, and memory/storage for data and modules, etc. which may be utilized in conjunction with embodiments of the present invention.

FIG. 3A is a schematic diagram of is a framework for sample classification by using the MIXP approach, and FIG. 3B is a related graph illustration.

FIG. 4 is a Venn diagram illustrating the Overlap between Alzheimer's disease (AD) genes from Online Mendelian Inheritance in Man (OMIM) and AlzGene databases

FIG. 5 is network diagram illustrating AD-specific PPI network layout with average differential expressions for incipient AD status vs. control. Node size is gene weight, node shade indicates differential expression levels, with the I-class seed genes being circled.

FIG. 6 is a network diagram illustrating AD-specific PPI network layout with average differential expressions for moderate AD status vs. control. Node size is gene weight, node shade indicates differential expression levels, with the I-class seed genes being circled.

FIG. 7 is a network diagram illustrating AD-specific PPI network layout with average differential expressions for severe AD status vs. control. Node size is gene weight, node shade indicates differential expression levels, with the I-class seed genes being circled.

FIG. 8 is a heat map diagram illustrating the reordered adjacent matrix of the AD-specific PPI network (Part A) and the corresponding average ACOR-based MIXP profiles for the three contrasts (Part B).

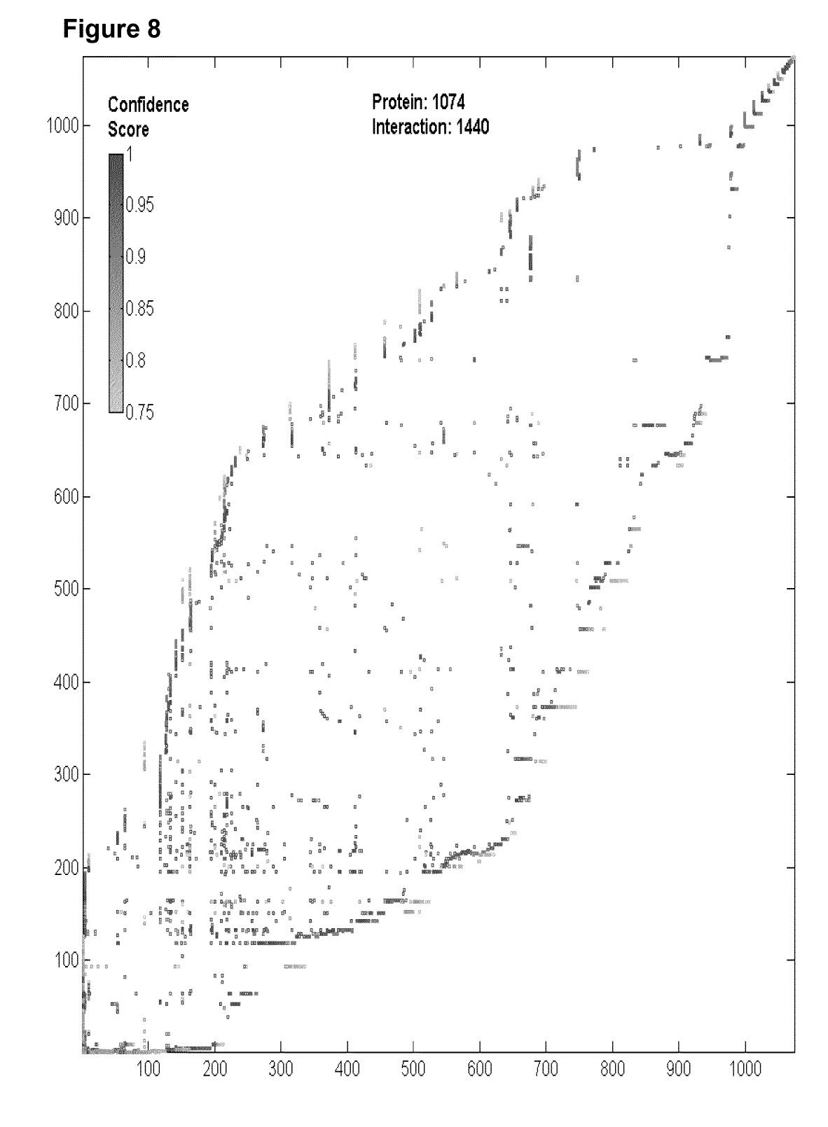

FIG. 9 is a chart diagram illustrating the performance comparisons of sample classification for different MIXP approaches, based on ACOR algorithm, network ranking, graph clustering, and randomly-ordering (RandRank), with different coefficient r in Equation (2). UniWeight: unified gene weights (all equal to one).

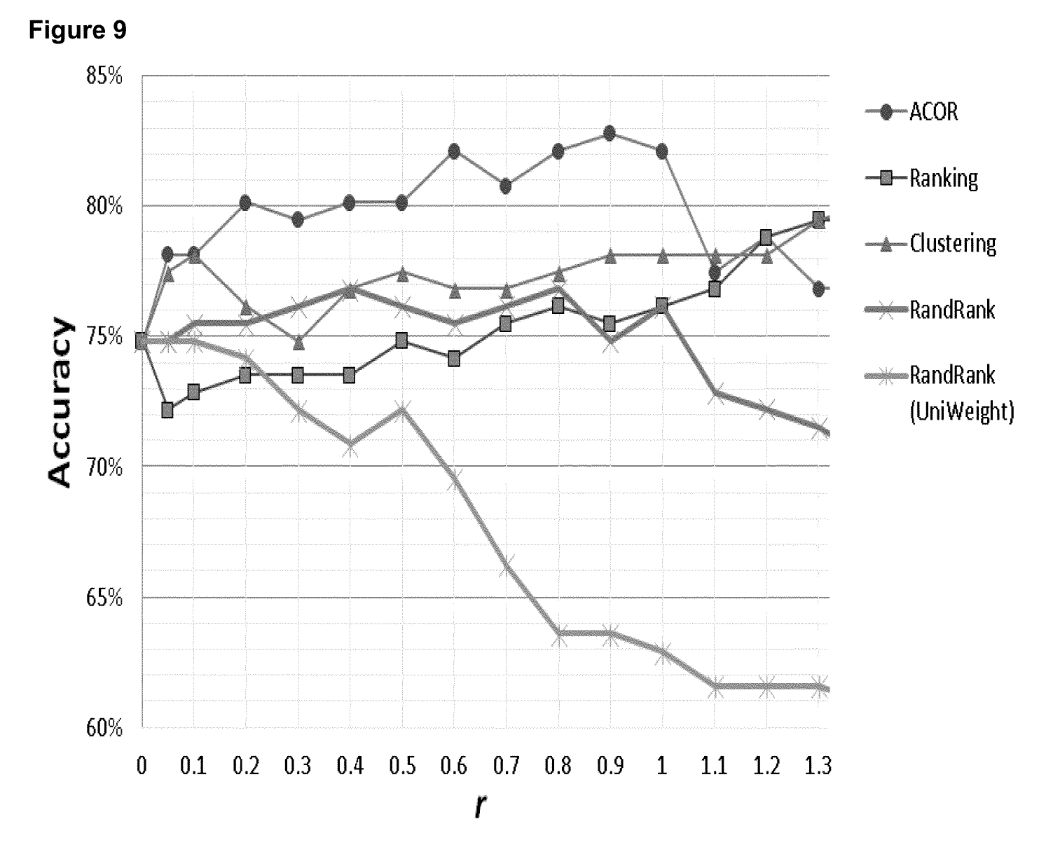

Corresponding reference characters indicate corresponding parts throughout the several views. Although the drawings represent embodiments of the present invention, the drawings are not necessarily to scale and certain features may be exaggerated in order to better illustrate and explain the present invention. The flow charts and screen shots are also representative in nature, and actual embodiments of the invention may include further features or steps not shown in the drawings. The exemplification set out herein illustrates an embodiment of the invention, in one form, and such exemplifications are not to be construed as limiting the scope of the invention in any manner.

### DESCRIPTION OF EMBODIMENTS OF THE PRESENT INVENTION

The embodiment disclosed below is not intended to be exhaustive or limit the invention to the precise form disclosed in the following detailed description. Rather, the embodiment is chosen and described so that others skilled in the art may utilize its teachings.

In the field of molecular biology, gene expression profiling is the measurement of the activity (the expression) of thousands of genes at once, to create a global picture of cellular function including protein and other cellular building blocks. These profiles may, for example, distinguish between cells that are actively dividing or otherwise reacting to the current bodily condition, or show how the cells react to a particular treatment such as positive drug reactions or toxicity reactions. Many experiments of this sort measure an entire genome simultaneously, that is, every gene present in a particular cell, as well as other important metabolites and cellular building blocks.

DNA Microarray technology measures the relative activity of previously identified target genes. Sequence based techniques, like serial analysis of gene expression (SAGE, SuperSAGE) are also used for gene expression profiling. SuperSAGE is especially accurate and may measure any active gene, not just a predefined set. The advent of next-generation sequencing has made sequence based expression analysis an increasingly popular, “digital” alternative to microarrays called RNA-Seq.

Expression profiling provides a view to what a patient's genetic materials are actually doing at a point in time. Genes contain the instructions for making messenger RNA (mRNA), but at any moment each cell makes mRNA from only a fraction of the genes it carries. If a gene is used to produce mRNA, it is considered “on”, otherwise “off”. Many factors determine whether a gene is on or off, such as the time of day, whether or not the cell is actively dividing, its local environment, and chemical signals from other cells. For instance, skin cells, liver cells and nerve cells turn on (express) somewhat different genes and that is in large part what makes them different. Therefore, an expression profile allows one to deduce a cell's type, state, environment, and so forth.

Expression profiling experiments often involve measuring the relative amount of mRNA expressed in two or more experimental conditions. For example, genetic databases have been created that reflect a normative state of a healthy patient, which may be contrasted with databases that have been created from a set of patient's with a particular disease or other condition. This contrast is relevant because altered levels of a specific sequence of mRNA suggest a changed need for the protein coded for by the mRNA, perhaps indicating a homeostatic response or a pathological condition. For example, higher levels of mRNA coding for one particular disease is indicative that the cells or tissues under study are responding to the effects of the particular disease. Similarly, if certain cells, for example a type of cancer cells, express higher levels of mRNA associated with a particular transmembrane receptor than normal cells do, the expression of that receptor is indicative of cancer. A drug that interferes with this receptor may prevent or treat that type of cancer. In developing a drug, gene expression profiling may assess a particular drug's toxicity, for example by detecting changing levels in the expression of certain genes that constitute a biomarker of drug metabolism.

For a type of cell, the group of genes and other cellular materials whose combined expression pattern is uniquely characteristic to a given condition or disease constitutes the gene signature of this condition or disease. Ideally, the gene signature is used to detect a specific state of a condition or disease to facilitates selection of treatments. Gene Set Enrichment Analysis (GSEA) and similar methods take advantage of this kind of logic and uses more sophisticated statistics. Component genes in real processes display more complex behavior than simply expressing as a group, and the amount and variety of gene expression is meaningful. In any case, these statistics measure how different the behavior of some small set of genes is compared to genes not in that small set.

One way to analyze sets of genes and other cellular materials apparent in gene expression measurement is through the use of pathway models and network models. Many protein-protein interactions (PPIs) in a cell form protein interaction networks (PINs) where proteins are nodes and their interactions are edges. There are dozens of PPI detection methods to identify such interactions. In addition, gene regulatory networks (DNA-protein interaction networks) model the activity of genes which is regulated by transcription factors, proteins that typically bind to DNA. Most transcription factors bind to multiple binding sites in a genome. As a result, all cells have complex gene regulatory networks which may be combined with PPIs to link together these various connections. The chemical compounds of a living cell are connected by biochemical reactions which convert one compound into another. The reactions are catalyzed by enzymes. Thus, all compounds in a cell are parts of an intricate biochemical network of reactions which is called the metabolic network, which may further enhance PPI and/or DNA-protein network models. Further, signals are transduced within cells or in between cells and thus form complex signaling networks that may further augment such genetic interaction networks. For instance, in the MAPK/ERK pathway is transduced from the cell surface to the cell nucleus by a series of protein-protein interactions, phosphorylation reactions, and other events. Signaling networks typically integrate protein-protein interaction networks, gene regulatory networks, and metabolic networks.

The detailed descriptions which follow are presented in part in terms of algorithms and symbolic representations of operations on data bits within a computer memory representing genetic profiling information derived from patient sample data and populated into network models. A computer generally includes a processor for executing instructions and memory for storing instructions and data. When a general purpose computer has a series of machine encoded instructions stored in its memory, the computer operating on such encoded instructions may become a specific type of machine, namely a computer particularly configured to perform the operations embodied by the series of instructions. Some of the instructions may be adapted to produce signals that control operation of other machines and thus may operate through those control signals to transform materials far removed from the computer itself. These descriptions and representations are the means used by those skilled in the art of data processing arts to most effectively convey the substance of their work to others skilled in the art.

An algorithm is here, and generally, conceived to be a self-consistent sequence of steps leading to a desired result. These steps are those requiring physical manipulations of physical quantities. Usually, though not necessarily, these quantities take the form of electrical or magnetic pulses or signals capable of being stored, transferred, transformed, combined, compared, and otherwise manipulated. It proves convenient at times, principally for reasons of common usage, to refer to these signals as bits, values, symbols, characters, display data, terms, numbers, or the like as a reference to the physical items or manifestations in which such signals are embodied or expressed. It should be borne in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through sophisticated software systems. Data structures are not the information content of a memory, rather they represent specific electronic structural elements which impart or manifest a physical organization on the information stored in memory. More than mere abstraction, the data structures are specific electrical or magnetic structural elements in memory which simultaneously represent complex data accurately, often data modeling physical characteristics of related items, and provide increased efficiency in computer operation.

Further, the manipulations performed are often referred to in terms, such as comparing or adding, commonly associated with mental operations performed by a human operator. No such capability of a human operator is necessary, or desirable in most cases, in any of the operations described herein which form part of the present invention; the operations are machine operations. Useful machines for performing the operations of the present invention include general purpose digital computers or other similar devices. In all cases the distinction between the method operations in operating a computer and the method of computation itself should be recognized. The present invention relates to a method and apparatus for operating a computer in processing electrical or other (e.g., mechanical, chemical) physical signals to generate other desired physical manifestations or signals. The computer operates on software modules, which are collections of signals stored on a media that represents a series of machine instructions that enable the computer processor to perform the machine instructions that implement the algorithmic steps. Such machine instructions may be the actual computer code the processor interprets to implement the instructions, or alternatively may be a higher level coding of the instructions that is interpreted to obtain the actual computer code. The software module may also include a hardware component, wherein some aspects of the algorithm are performed by the circuitry itself rather as a result of an instruction.

The present invention also relates to an apparatus for performing these operations. This apparatus may be specifically constructed for the required purposes or it may comprise a general purpose computer as selectively activated or reconfigured by a computer program stored in the computer. The algorithms presented herein are not inherently related to any particular computer or other apparatus unless explicitly indicated as requiring particular hardware. In some cases, the computer programs may communicate or relate to other programs or equipments through signals configured to particular protocols which may or may not require specific hardware or programming to interact. In particular, various general purpose machines may be used with programs written in accordance with the teachings herein, or it may prove more convenient to construct more specialized apparatus to perform the required method steps. The required structure for a variety of these machines will appear from the description below.

The present invention may deal with “object-oriented” software, and particularly with an “object-oriented” operating system. The “object-oriented” software is organized into “objects”, each comprising a block of computer instructions describing various procedures (“methods”) to be performed in response to “messages” sent to the object or “events” which occur with the object. Such operations include, for example, the manipulation of variables, the activation of an object by an external event, and the transmission of one or more messages to other objects.

Messages are sent and received between objects having certain functions and knowledge to carry out processes. Messages are generated in response to user instructions, for example, by a user activating an icon with a “mouse” pointer generating an event. Also, messages may be generated by an object in response to the receipt of a message. When one of the objects receives a message, the object carries out an operation (a message procedure) corresponding to the message and, if necessary, returns a result of the operation. Each object has a region where internal states (instance variables) of the object itself are stored and where the other objects are not allowed to access. One feature of the object-oriented system is inheritance. For example, an object for drawing a “circle” on a display may inherit functions and knowledge from another object for drawing a “shape” on a display.

A programmer “programs” in an object-oriented programming language by writing individual blocks of code each of which creates an object by defining its methods. A collection of such objects adapted to communicate with one another by means of messages comprises an object-oriented program. Object-oriented computer programming facilitates the modeling of interactive systems in that each component of the system can be modeled with an object, the behavior of each component being simulated by the methods of its corresponding object, and the interactions between components being simulated by messages transmitted between objects.

An operator may stimulate a collection of interrelated objects comprising an object-oriented program by sending a message to one of the objects. The receipt of the message may cause the object to respond by carrying out predetermined functions which may include sending additional messages to one or more other objects. The other objects may in turn carry out additional functions in response to the messages they receive, including sending still more messages. In this manner, sequences of message and response may continue indefinitely or may come to an end when all messages have been responded to and no new messages are being sent. When modeling systems utilizing an object-oriented language, a programmer need only think in terms of how each component of a modeled system responds to a stimulus and not in terms of the sequence of operations to be performed in response to some stimulus. Such sequence of operations naturally flows out of the interactions between the objects in response to the stimulus and need not be preordained by the programmer.

Although object-oriented programming makes simulation of systems of interrelated components more intuitive, the operation of an object-oriented program is often difficult to understand because the sequence of operations carried out by an object-oriented program is usually not immediately apparent from a software listing as in the case for sequentially organized programs. Nor is it easy to determine how an object-oriented program works through observation of the readily apparent manifestations of its operation. Most of the operations carried out by a computer in response to a program are “invisible” to an observer since only a relatively few steps in a program typically produce an observable computer output.

In the following description, several terms which are used frequently have specialized meanings in the present context. The term “object” relates to a set of computer instructions and associated data which can be activated directly or indirectly by the user. The terms “windowing environment”, “running in windows”, and “object oriented operating system” are used to denote a computer user interface in which information is manipulated and displayed on a video display such as within bounded regions on a raster scanned video display. The terms “network”, “local area network”, “LAN”, “wide area network”, or “WAN” mean two or more computers which are connected in such a manner that messages may be transmitted between the computers. In such computer networks, typically one or more computers operate as a “server”, a computer with large storage devices such as hard disk drives and communication hardware to operate peripheral devices such as printers or modems. Other computers, termed “workstations”, provide a user interface so that users of computer networks can access the network resources, such as shared data files, common peripheral devices, and inter-workstation communication. Users activate computer programs or network resources to create “processes” which include both the general operation of the computer program along with specific operating characteristics determined by input variables and its environment. Similar to a process is an agent (sometimes called an intelligent agent), which is a process that gathers information or performs some other service without user intervention and on some regular schedule. Typically, an agent, using parameters typically provided by the user, searches locations either on the host machine or at some other point on a network, gathers the information relevant to the purpose of the agent, and presents it to the user on a periodic basis. A “module” refers to a portion of a computer system and/or software program that carries out one or more specific functions and may be used alone or combined with other modules of the same system or program.

The term “desktop” means a specific user interface which presents a menu or display of objects with associated settings for the user associated with the desktop. When the desktop accesses a network resource, which typically requires an application program to execute on the remote server, the desktop calls an Application Program Interface, or “API”, to allow the user to provide commands to the network resource and observe any output. The term “Browser” refers to a program which is not necessarily apparent to the user, but which is responsible for transmitting messages between the desktop and the network server and for displaying and interacting with the network user. Browsers are designed to utilize a communications protocol for transmission of text and graphic information over a world wide network of computers, namely the “World Wide Web” or simply the “Web”. Examples of Browsers compatible with the present invention include the Internet Explorer program sold by Microsoft Corporation (Internet Explorer is a trademark of Microsoft Corporation), the Opera Browser program created by Opera Software ASA, or the Firefox browser program distributed by the Mozilla Foundation (Firefox is a registered trademark of the Mozilla Foundation). Although the following description details such operations in terms of a graphic user interface of a Browser, the present invention may be practiced with text based interfaces, or even with voice or visually activated interfaces, that have many of the functions of a graphic based Browser.

Browsers display information which is formatted in a Standard Generalized Markup Language (“SGML”) or a HyperText Markup Language (“HTML”), both being scripting languages which embed non-visual codes in a text document through the use of special ASCII text codes. Files in these formats may be easily transmitted across computer networks, including global information networks like the Internet, and allow the Browsers to display text, images, and play audio and video recordings. The Web utilizes these data file formats to conjunction with its communication protocol to transmit such information between servers and workstations. Browsers may also be programmed to display information provided in an eXtensible Markup Language (“XML”) file, with XML files being capable of use with several Document Type Definitions (“DTD”) and thus more general in nature than SGML or HTML. The XML file may be analogized to an object, as the data and the stylesheet formatting are separately contained (formatting may be thought of as methods of displaying information, thus an XML file has data and an associated method).

The terms “personal digital assistant” or “PDA”, as defined above, means any handheld, mobile device that combines computing, telephone, fax, e-mail and networking features. The terms “wireless wide area network” or “WWAN” mean a wireless network that serves as the medium for the transmission of data between a handheld device and a computer. The term “synchronization” means the exchanging of information between a first device, e.g. a handheld device, and a second device, e.g. a desktop computer, either via wires or wirelessly. Synchronization ensures that the data on both devices are identical (at least at the time of synchronization).

In wireless wide area networks, communication primarily occurs through the transmission of radio signals over analog, digital cellular or personal communications service (“PCS”) networks. Signals may also be transmitted through microwaves and other electromagnetic waves. At the present time, most wireless data communication takes place across cellular systems using second generation technology such as code-division multiple access (“CDMA”), time division multiple access (“TDMA”), the Global System for Mobile Communications (“GSM”), Third Generation (wideband or “3G”), Fourth Generation (broadband or “4G”), personal digital cellular (“PDC”), or through packet-data technology over analog systems such as cellular digital packet data (CDPD″) used on the Advance Mobile Phone Service (“AMPS”).

The terms “wireless application protocol” or “WAP” mean a universal specification to facilitate the delivery and presentation of web-based data on handheld and mobile devices with small user interfaces. “Mobile Software” refers to the software operating system which allows for application programs to be implemented on a mobile device such as a mobile telephone or PDA. Examples of Mobile Software are Java and Java ME (Java and JavaME are trademarks of Sun Microsystems, Inc. of Santa Clara, Calif.), BREW (BREW is a registered trademark of Qualcomm Incorporated of San Diego, Calif.), Windows Mobile (Windows is a registered trademark of Microsoft Corporation of Redmond, Wash.), Palm OS (Palm is a registered trademark of Palm, Inc. of Sunnyvale, Calif.), Symbian OS (Symbian is a registered trademark of Symbian Software Limited Corporation of London, United Kingdom), ANDROID OS (ANDROID is a registered trademark of Google, Inc. of Mountain View, Calif.), and iPhone OS (iPhone is a registered trademark of Apple, Inc. of Cupertino, Calif.), and Windows Phone 7. “Mobile Apps” refers to software programs written for execution with Mobile Software.

“PACS” refers to Picture Archiving and Communication System (PACS) involving medical imaging technology for storage of, and convenient access to, images from multiple source machine types. Electronic images and reports are transmitted digitally via PACS; this eliminates the need to manually file, retrieve, or transport film jackets. The universal format for PACS image storage and transfer is DICOM (Digital Imaging and Communications in Medicine). Non-image data, such as scanned documents, may be incorporated using consumer industry standard formats like PDF (Portable Document Format), once encapsulated in DICOM. A PACS typically consists of four major components: imaging modalities such as X-ray computed tomography (CT) and magnetic resonance imaging (MRI) (although other modalities such as ultrasound (US), positron emission tomography (PET), endoscopy (ES), mammograms (MG), Digital radiography (DR), computed radiography (CR), etc. may be included), a secured network for the transmission of patient information, workstations and mobile devices for interpreting and reviewing images, and archives for the storage and retrieval of images and reports. When used in a more generic sense, PACS may refer to any image storage and retrieval system.

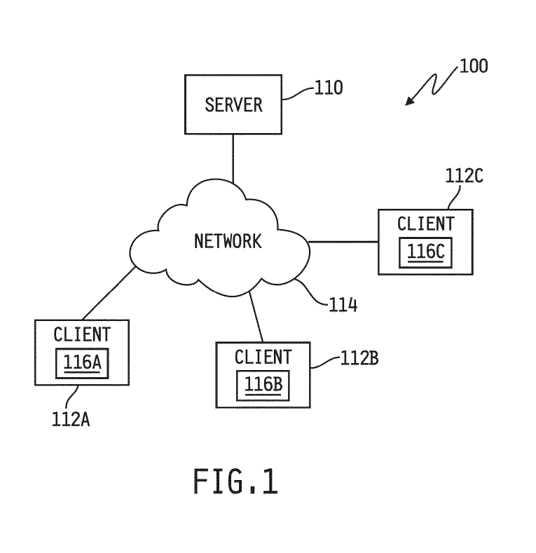

FIG. 1 is a high-level block diagram of a computing environment 100 according to one embodiment. FIG. 1 illustrates server 110 and three clients 112 connected by network 114. Only three clients 112 are shown in FIG. 1 in order to simplify and clarify the description. Embodiments of the computing environment 100 may have thousands or millions of clients 112 connected to network 114, for example the Internet. Users (not shown) may operate software 116 on one of clients 112 to both send and receive messages network 114 via server 110 and its associated communications equipment and software (not shown).

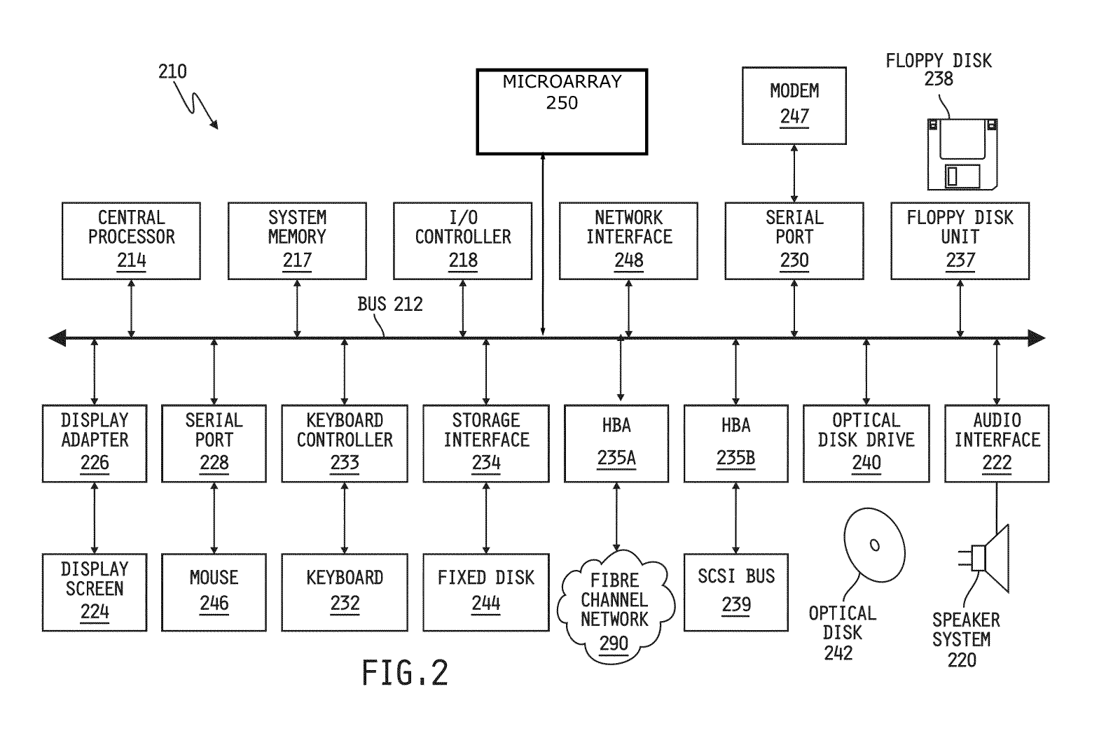

FIG. 2 depicts a block diagram of computer system 210 suitable for implementing server 110 or client 112. Computer system 210 includes bus 212 which interconnects major subsystems of computer system 210, such as central processor 214, system memory 217 (typically RAM, but which may also include ROM, flash RAM, or the like), input/output controller 218, external audio device, such as speaker system 220 via audio output interface 222, external device, such as display screen 224 via display adapter 226, serial ports 228 and 230, keyboard 232 (interfaced with keyboard controller 233), storage interface 234, disk drive 237 operative to receive floppy disk 238, host bus adapter (HBA) interface card 235A operative to connect with Fibre Channel network 290, host bus adapter (HBA) interface card 235B operative to connect to SCSI bus 239, and optical disk drive 240 operative to receive optical disk 242. Also included are mouse 246 (or other point-and-click device, coupled to bus 212 via serial port 228), modem 247 (coupled to bus 212 via serial port 230), and network interface 248 (coupled directly to bus 212).

Bus 212 allows data communication between central processor 214 and system memory 217, which may include read-only memory (ROM) or flash memory (neither shown), and random access memory (RAM) (not shown), as previously noted. RAM is generally the main memory into which operating system and application programs are loaded. ROM or flash memory may contain, among other software code, Basic Input-Output system (BIOS) which controls basic hardware operation such as interaction with peripheral components. Applications resident with computer system 210 are generally stored on and accessed via computer readable media, such as hard disk drives (e.g., fixed disk 244), optical drives (e.g., optical drive 240), floppy disk unit 237, or other storage medium. Additionally, applications may be in the form of electronic signals modulated in accordance with the application and data communication technology when accessed via network modem 247 or interface 248 or other telecommunications equipment (not shown).

Storage interface 234, as with other storage interfaces of computer system 210, may connect to standard computer readable media for storage and/or retrieval of information, such as fixed disk drive 244. Fixed disk drive 244 may be part of computer system 210 or may be separate and accessed through other interface systems. Modem 247 may provide direct connection to remote servers via telephone link or the Internet via an internet service provider (ISP) (not shown). Network interface 248 may provide direct connection to remote servers via direct network link to the Internet via a POP (point of presence). Network interface 248 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 2 need not be present to practice the present disclosure. Devices and subsystems may be interconnected in different ways from that shown in FIG. 2. Operation of a computer system such as that shown in FIG. 2 is readily known in the art and is not discussed in detail in this application. Software source and/or object codes to implement the present disclosure may be stored in computer-readable storage media such as one or more of system memory 217, fixed disk 244, optical disk 242, or floppy disk 238. The operating system provided on computer system 210 may be a variety or version of either MS-DOS® (MS-DOS is a registered trademark of Microsoft Corporation of Redmond, Wash.), WINDOWS® (WINDOWS is a registered trademark of Microsoft Corporation of Redmond, Wash.), OS/2® (OS/2 is a registered trademark of International Business Machines Corporation of Armonk, N.Y.), UNIX® (UNIX is a registered trademark of X/Open Company Limited of Reading, United Kingdom), Linux® (Linux is a registered trademark of Linus Torvalds of Portland, Oreg.), or other known or developed operating system. In some embodiments, computer system 210 may take the form of a tablet computer, typically in the form of a large display screen operated by touching the screen. In tablet computer alternative embodiments, the operating system may be iOS® (iOS is a registered trademark of Cisco Systems, Inc. of San Jose, Calif., used under license by Apple Corporation of Cupertino, Calif.), Android® (Android is a trademark of Google Inc. of Mountain View, Calif.), Blackberry® Tablet OS (Blackberry is a registered trademark of Research In Motion of Waterloo, Ontario, Canada), webOS (webOS is a trademark of Hewlett-Packard Development Company, L.P. of Texas), and/or other suitable tablet operating systems.

Moreover, regarding the signals described herein, those skilled in the art recognize that a signal may be directly transmitted from a first block to a second block, or a signal may be modified (e.g., amplified, attenuated, delayed, latched, buffered, inverted, filtered, or otherwise modified) between blocks. Although the signals of the above described embodiments are characterized as transmitted from one block to the next, other embodiments of the present disclosure may include modified signals in place of such directly transmitted signals as long as the informational and/or functional aspect of the signal is transmitted between blocks. To some extent, a signal input at a second block may be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

One peripheral device particularly useful with embodiments of the present invention is microarray 250. Generally, microarray 250 represents one or more devices capable of analyzing and providing genetic expression and other molecular information from patients. Microarrays may be manufactured in different ways, depending on the number of probes under examination, costs, customization requirements, and the type of analysis contemplated. Such arrays may have as few as 10 probes or over a million micrometre-scale probes, and are generally available from multiple commercial vendors. Each probe in a particular array is responsive to one or more genes, gene-expressions, proteins, enzymes, metabolites and/or other molecular materials, collectively referred to hereinafter as targets or target products.

In some embodiments, gene expression values from microarray experiments may be represented as heat maps to visualize the result of data analysis. In other embodiments, the gene expression values are mapped into a network structure and compared to other network structures, e.g. normalized samples and/or samples of patients with a particular condition or disease. In either circumstance, a simple patient sample may be analyzed and compared multiple times to focus or differentiate diagnoses or treatments. Thus, a patient having signs of multiple conditions or diseases may have microarray sample data analyzed several times to clarify possible diagnoses or treatments.

It is also possible, in several embodiments, to have multiple types of microarrays, each type having sensitivity to particular expressions and/or other molecular materials, and thus particularized for a predetermined set of targets. This allows for an iterative process of patient sampling, analysis, and further sampling and analysis to refine and personalize diagnoses and treatments for individuals. While each commercial vendor may have particular platforms and data formats, most if not all may be reduced to standardized formats. Further, sample data may be subject to statistical treatment for analysis and/or accuracy and precision so that individual patient data is a relevant as possible. Such individual data may be compared to large databases having thousands or millions sets of comparative data to assist in the experiment, and several such databases are available in data warehouses and available to the public. Due to the biological complexity of gene expression, the considerations of experimental design are necessary so that statistically and biologically valid conclusions may be drawn from the data.

Microarray data sets are commonly very large, and analytical precision is influenced by a number of variables. Statistical challenges include taking into account effects of background noise and appropriate normalization of the data. Normalization methods may be suited to specific platforms and, in the case of commercial platforms, some analysis may be proprietary. The relation between a probe and the mRNA that it is expected to detect is not trivial. Some mRNAs may cross-hybridize probes in the array that are supposed to detect another mRNA. In addition, mRNAs may experience amplification bias that is sequence or molecule-specific. Thirdly, probes that are designed to detect the mRNA of a particular gene may be relying on genomic Expression Sequence Tag (EST) information that is incorrectly associated with that gene.

To address the challenge of therapeutic decision-making based on molecular profiles and to develop genomic predictive medicine, we propose an innovative concept—Multi-dimensional Integrative eXpression Profiling (MIXP)—which can not only improve sample classification accuracy by serving as a feature transformation approach, but also help in the discovery of groups of genes that have been too weak to detect individually through existing methods.

To implement MIXP, first related genes are grouped functionally together in an ordered way. Traditional network analysis, such as network ranking and network clustering, often fail to find patterns in ranked or clustered adjacency matrix of a network when facing complex networks that have higher inseparability. In the traditional analysis, no “clear cluster” or “absolute rank” exists. Embodiments of the present invention's network reordering algorithm achieve the optimization.

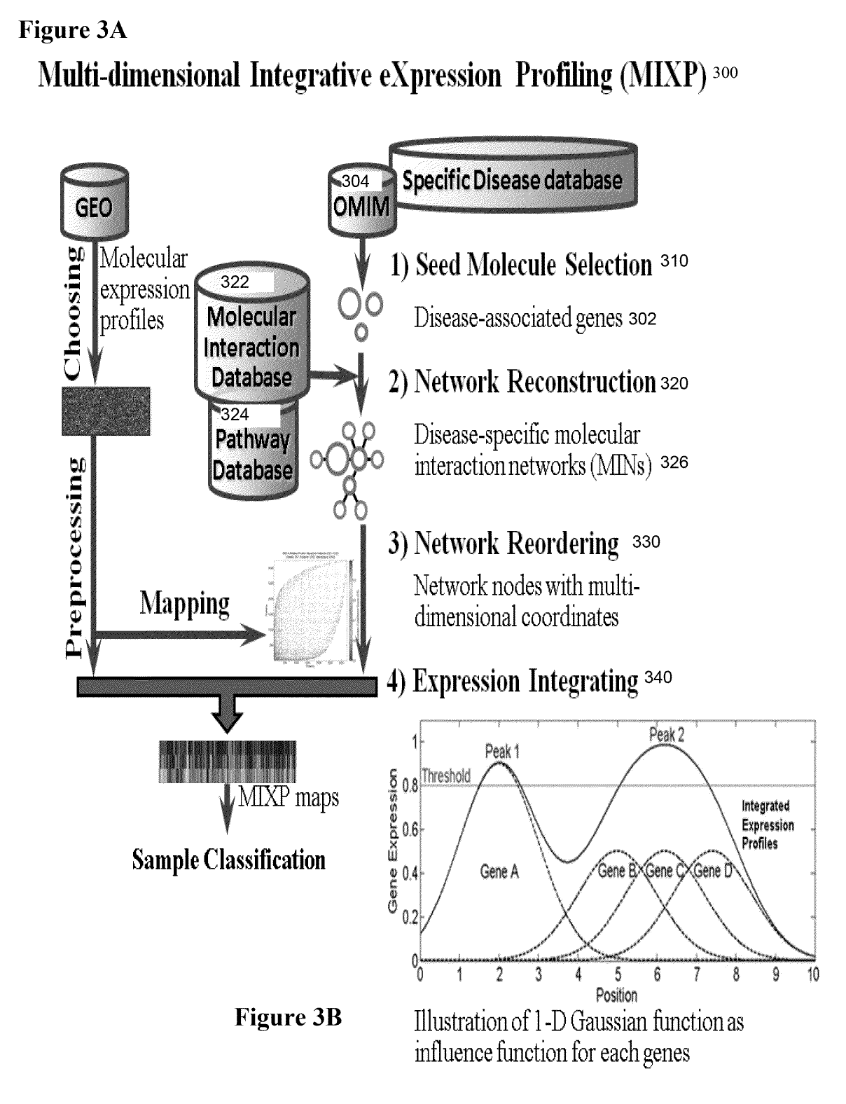

Framework 300 for sample classification by using MIXP approach based on network reordering is shown as an exemplary embodiment in FIG. 3. The MIXP modeling approach includes four steps:

1) Seed Molecule Selection 310. Disease-associated molecular entities 302 (e.g., genes, proteins, metabolites, or RNAs) are selected from Online Mendelian Inheritance in Man (OMIM) 304 databases and/or other specific disease-related molecule databases as seed molecules. One may start with any disease-specific data set for any given biological study, e.g., based on genetic association studies, functional genetic studies, or proteomics/metabolomics studies on particular personal health situations—disease or condition. Each such credible study or integration of such study results may be compiled into a seed molecule set for the specific study condition.

2) Network Reconstruction 320. Disease-specific molecular interaction network model 326 is constructed by expanding the seed molecules (disease-associated molecular entities) in human molecular interaction databases 322 and/or human pathway databases 324. Examples of human molecular interaction databases are the Human Protein Reference Database (HPRD, at http://www.hprd.orgZ), the Biological General Repository for Interaction Datasets (BioGRID, at http://thebiogrid.org/), Human Annotated and Predicted Protein Interactions (HAPPI) database, the Database of Interacting Proteins (DIP, at http://dip.doe-mbi.ucla.edu/dip/Main.cgi) by the University of California at Los Angeles, and the Molecular Interaction database (MINT, at (http://mint.bio.uniroma2.it/mint/Welcome.do) by University of Roma. Examples of human pathway databases are the Kyoto Encyclopedia of Genes and Genomes (KEGG) database by Kanehisa Laboratories, Kyoto University & University of Tokyo; the Reactome database (http://www.reactome.org) by the National Institutes of Health, Enfin of the European Union, and Ontario, Canada, New York University, and Cold Spring Harbor Laboratory; the National Cancer Institute's curated PID (“Nature Curated pathways” at http://pid.nci.nih.gov/), and the Pathway And Gene Enhanced Database (PAGED) database by Indiana University School of Informatics (http://bio.informatics.iupui.edu/paged/). These molecular interaction databases and pathway databases provide biomolecular interactions, gene sets, network modules, and pathways related to the initial disease-specific seed proteins.

3) Network Reordering 330. A network reordering algorithm is applied in reordering the adjacency matrix of the constructed disease-specific molecular interaction network.

4) Expression Integrating 340. The molecular expression profile for each sample is mapped to the ordered molecule list, and integrated by using an influence function (e.g., Gaussian function) for each molecule.

To integrate molecular expressions onto the molecule list reordered from the disease-specific molecular interaction networks we use our network reordering algorithm. As illustrated in the fourth step—Expression Integrating shown in FIG. 3, three closely ordered genes (B, C and D) form a new peak which is even greater than the peak formed by single gene (A) in integrated profiles. These three genes might otherwise be neglected with original expression profiling methods due to their lowly differentially-expressed values. In the approach of embodiments of the present invention, if genes/proteins interact with each other, they will be put into neighboring orders.

Here we use one dimensional (1-D) Gaussian function as an example to demonstrate how to integrate molecular expressions. We use an ant colony optimization reordering (ACOR) algorithm as an example for network reordering. In the ACOR algorithm, the task of reordering nodes is represented as the problem of finding optimal density distributions of “ant colonies” on all nodes of the network, in which simulated ants roam all possible network paths iteratively. According to this density distribution, the adjacency matrix of the network with ranked nodes is shown as a heat map to reveal the system-level features of the network.

Here we use Alzheimer's disease (AD) as an example, to demonstrate how to apply ACOR-based MIXP approach to the blinded classification on a microarray dataset—GSE5281 with 151 samples (testing set, 67 controls and 84 AD patients), by using another much smaller microarray dataset—GSE1297 with 31 samples (9 controls and 22 AD patients) as a training set.

1. Gene Expression Profiles:

The gene expression microarray datasets—GSE1297 (training set) and GSE5281 (testing set)—in our case study on AD are downloaded both from GEO (http://www.ncbi.nlm.nih.gov/geo/). GSE1297 contains 20273 Probe IDs (mapped to 12679 genes) and 31 samples, divided into four groups—9 healthy controls, 7 incipient AD patients, 8 moderate AD patients, and 7 severe AD patients. GSE5281 contains 40801 Probe Ids (mapped to 19700 genes) and 161 samples, from which 151 samples (67 controls and 84 AD patients) are selected out after quality control. There are 12679 genes (gene symbol) overlapped between GSE1297 and GSE5281, which mapped to 12076 proteins (Uniprot ID), as features for classification. Maximal expression values are used for same proteins mapped from different Probe Ids. The Affy package in BioConductor is used in this exemplary embodiment for quantile normalization, although other similar software may be utilized. For background correction, the built-in MicroArray Suite (MAS5) method may be used, although other suitable methods of background correction are equally suitable.

2. Seed Gene Selection:

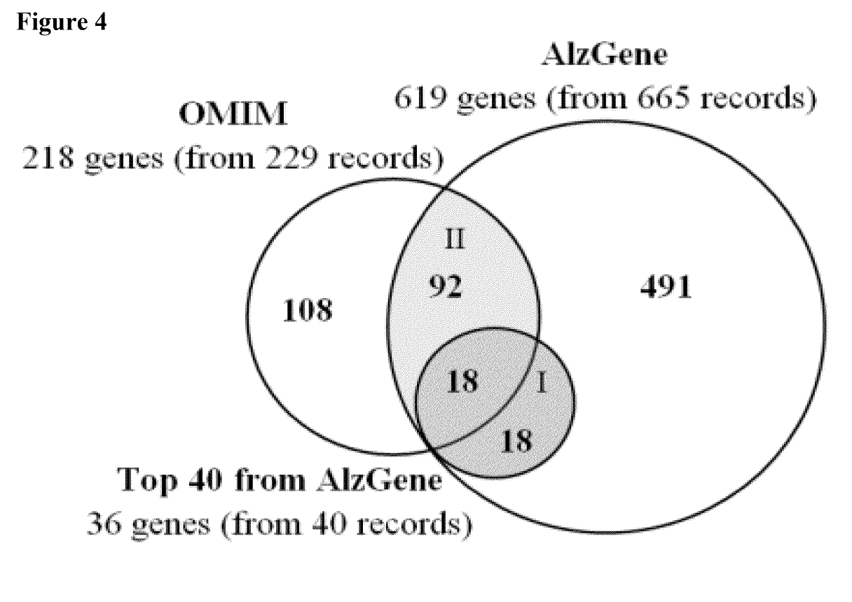

As shown in the first step in FIG. 3, disease-associated genes are selected from OMIM (http://www.ncbi.nlm.nih.gov/omim) and/or other specific disease gene databases, e.g. AlzGene (http://www.alzgene.org/) for AD-associated genes (simply, AD genes). In this study, we first choose 36 AD genes mapped from the Top 40 ranked genes/miRNAs/loci in AlzGene to Uniprot ID, as I-class seed genes. Then we choose 110 AD genes (shown in FIG. 4) overlapped with 619 genes (mapped from 665 records till May 12, 2010) from AlzGene and 218 genes from OMIM (mapped from 229 records till Aug. 19, 2010), as II-class seed genes. This approach assumes that these genes should show high significance both in the literature and GWAS studies on AD.

3. Network Construction:

To optimize computation time and information generation, we use a combined network construction strategy, based on both I-class and II-class AD seed genes. We first expand the 36 I-class seed genes in HAPPI with confidence score (CI>=0.75, i.e. 4-star rating) for interactions, by using nearest neighbor expansion (NNE) algorithm, to obtain a PPI network with 516 proteins and 619 interactions. Then we expand the 110 II-class seed genes in HAPPI with confidence score (CI>=0.90, i.e. 5-star rating) for interactions, by using NNE algorithm, to obtain a PPI network with 755 proteins and 960 interactions. Finally, we combine these two networks to construct a node-weighted edge-scored AD-specific PPI network, containing 1074 proteins with node weights calculated by Wₜ={log10 (Node_Degreeᵢ)+1}/3, and 1440 interactions with edge scores for their confidence scores.

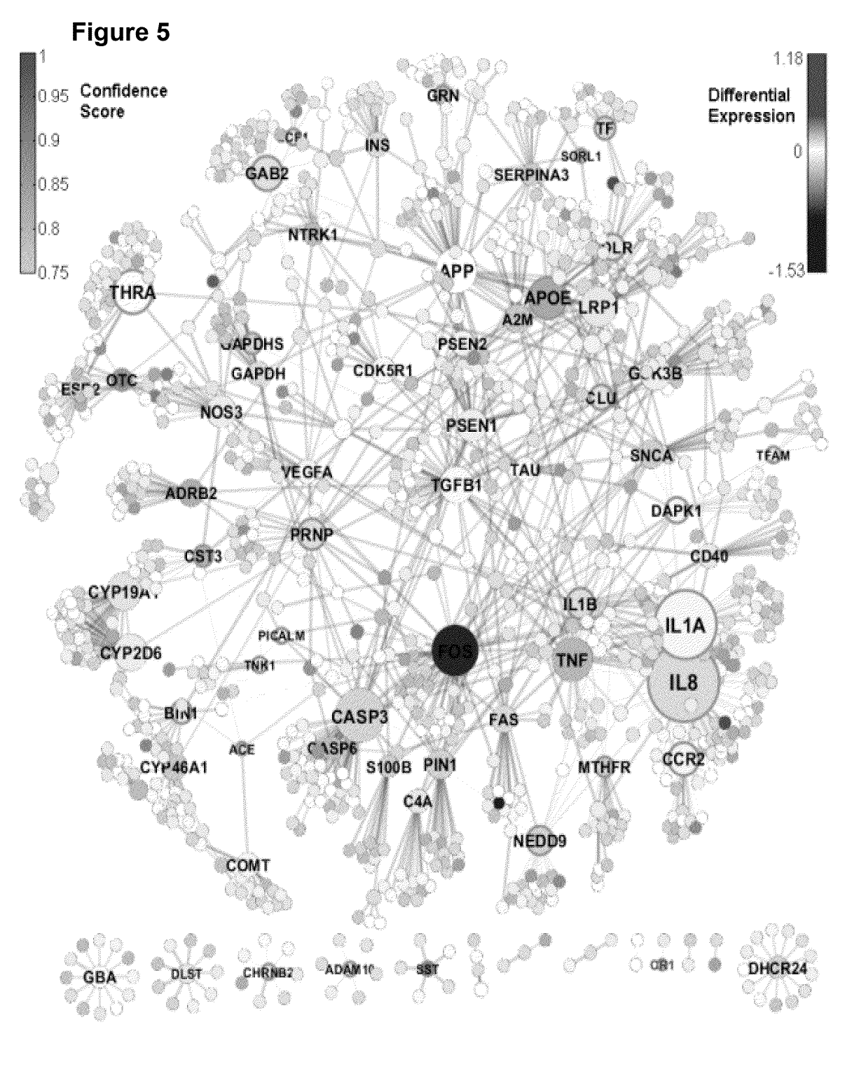

We also calculate the average differential expression values for the three AD status groups (incipient, moderate, and severe) vs. control group in GSE1297, and map them onto the genes in the network by representing them as node colors, as shown in FIGS. 3, 4, and 5 respectively. 969 genes (90.2%) show expressions. From the comparisons of FIGS. 3-5, we can see that differential expression increases from incipient to moderate, and then to severe AD status. This finding shows the validity of the network construction method of embodiments of the present invention, since this network is built specific for AD and the node color change directly reflects average gene expression shifts from incipient to severe AD. Moreover, not only hub genes (shown as relatively large sizes) and seed genes (circled) are differentially expressed in different AD status, but also many non-hub genes (shown as relatively small sizes) surrounding hub genes are highly differentially expressed. This shows how MIXP may make these “trivial” genes contribute the microarray classification.

4. Network Reordering:

Ant colony optimization (ACO) is a dynamic stochastic searching (i.e. random walking) algorithm for finding optimal paths. The algorithm is based on the behavior of ants searching for food. ACO is also like another kind of dynamic method called “flow simulation”, which can be used as a graph clustering algorithm for the detection of protein families, or as a classifying algorithm for the prediction of protein functions.

To fulfill the task of network reordering, we use the ant colony optimization reordering (ACOR) algorithm under populated mode, in which simulated ants (s-ant) roam all possible network paths iteratively and populate quickly (total population of s-ant colony increases rapidly). As shown in Equation (1), the iteration process may be manipulated to get the density distribution sᵢ of s-ants crowding on each node. According to this density sᵢ, the reordered adjacency matrix of the network may be shown as a heat map to reveal the system-level features of the network.

sᵢ₊₁=Pᵢ×sᵢ,PᵢεR^{n×n},sᵢεRⁿ,s₀=(1/n,1/n, . . . ,1/n)^{t}

Pᵢ₊₁=Pᵢ(cᵢ,cᵢ),cᵢ=Ordering(sᵢ),i=0,1, . . . ,N−1 (1)

Here sᵢ denotes i th step density distribution of s-ants crowding on each node, P is the adjacency matrix of a network, cᵢ is a permutation vector according to i th step density distribution sᵢ, and Pᵢ (cᵢ, cᵢ) is the reordered adjacency matrix with the permutation cᵢ. The iteration process is manipulated until the permutation cᵢ changes little.

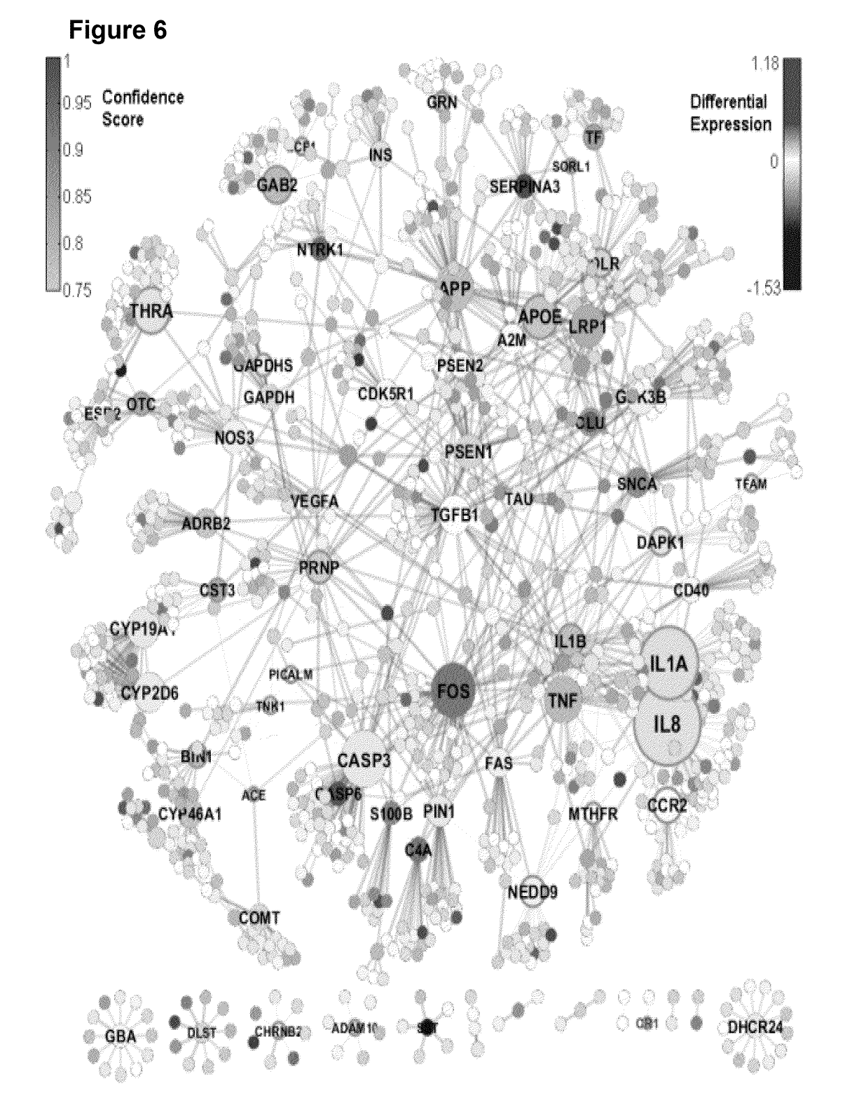

The ACOR algorithm under populated mode to reorder the AD-specific PPI network is used. The reordered adjacency matrix is plotted in FIG. 6A, which shows a fractal-like pattern also reported in another study on AD-specific PPI network, while using different seed genes. The data indicates that the ACOR algorithm is robust on different seed gene selection and network construction processes. Since both the X and Y axes in FIG. 6A denote reordering indexes (1-1074) of proteins, we also investigate the relative position for each protein. From the genes labeled in FIG. 6B (with the same order of FIG. 6A), we find almost all the I-class seed genes appear in the fringe of the left-bottom “head”, while most II-class seed genes appear in the fringe of the “main body”. This finding implies that the ACOR algorithm may not only group functionally related genes together (clustering capability), but also put them in a meaningful order (ranking capability). This combined characteristic (generating relative ranks in clusters, finally causing fractal-like patterns) is advantageous to embodiments of the invention, enhancing the effects of the MIXP approach. The data also shows that this order performs better than both classical ranking and clustering in microarray classification by MIXP.

5. Expression Integrating:

The gene expression profile for each sample is mapped onto the gene list reordered by the ACOR algorithm under populated mode. The integrated expression profile MIXP(t) is calculated by simply using 1-D Gaussian function as an influence function for each gene, and then by adding up the influence functions from all the genes together, as shown in Equation (2).

$$MIXP ( t ) = {\sum }_{i = 1}^{L} \vert {E}_{i} \vert {e}^{\frac{1}{{rW}_{i}} {( t - i )}^{2}} , \\ t = 1 , … , L \qquad ( 2 )$$

Here L is the length of the gene list and r is a horizontal influence coefficient for all genes. The normalized gene expression value E, determines the vertical influence of gene i. The weight value Wᵢ is calculated from node degree as described in Network Construction Section, which determines the horizontal influence of gene i. An illustration for this function can also be found in the fourth Step in FIG. 3.

The average differential expression values for the three AD status groups may be mapped onto the gene list reordered by the ACOR algorithm. All the expression values for each group may be integrated by using the MIXP described by Equation (2). The integrated average expression profiles for the three AD status groups in GSE1297 are shown in FIG. 6B. The profiles clearly indicate the distinctions among these three AD status groups and indicate the genes' differential expression increases from incipient to moderate, and then to severe AD status. This result not only verifies the usefulness of our MIXP method, but also validates our network construction method in a neater way than in network visualization.

6. Sample Classification:

Support vector machine (SVM) type 2 with linear kernel is used through the microarray classifications. Before classification, inputted features (gene expression values for each sample) may be scaled to normal distribution with zero mean and one standard deviation.

By using GSE1297 as training set (31 samples, 22 AD patients vs. 9 controls), and GSE5281 (151 samples, 84 AD patients vs. 67 controls) as testing set, we perform two-class (AD vs. control) classifications for ACOR-based MIXP approach with different horizontal influence coefficient r in Equation (2). We also perform classifications for the MIXP approaches based on network ranking (similar with PageRank algorithm used by Google, equal to random walk ranking), graph clustering (2D hierarchical clustering), and on randomly-ordering (a random permutation of all network nodes), with different coefficient r.

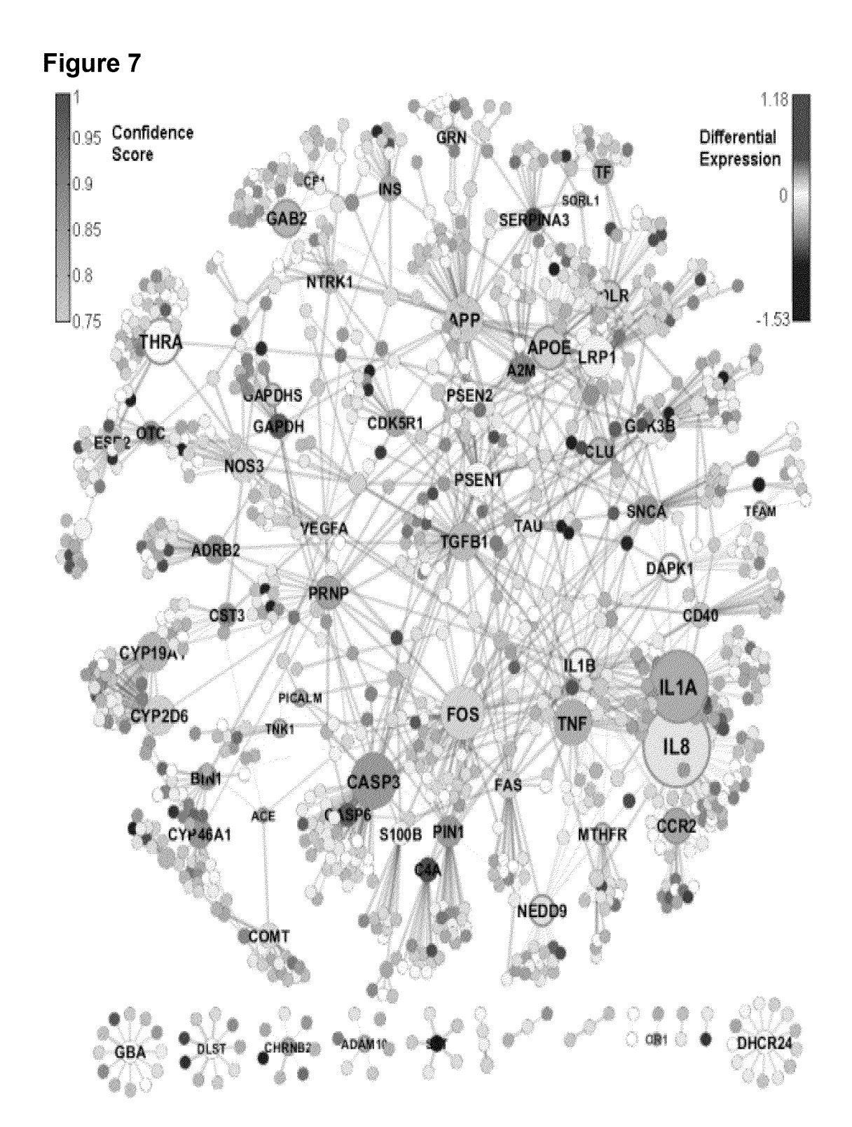

Here we use exactly the same gene weights calculated from node degree in the network to generate MIXP profiles. The only difference here is the order of proteins in the network. For comparison's sake, MIXP profiles based on the same permutation, but with unified gene weights (all equal to one), are generated. In FIG. 7, the result for the blinded classification on GSE5281 shows that the ACOR-based MIXP approach may improve accuracy from 74.83% (equal to r=0) to 82.78% (r=0.9) by using SVM classifier.

From the blinded classifications on the testing microarray dataset with sample size 4 times bigger than the training microarray dataset from different microarray platforms, the ACOR-based MIXP approach serves as a knowledge-supervised feature transformation approach that increases classification accuracy dramatically. This approach transforms gene expression profiles to integrated expression files as features inputting into the classifier. The ACOR-based MIXP approach also has better performance than the MIXP approach based on ranking, clustering, and random-ordering. Since gene weights represent local topological properties and gene orders represent global topological characteristics, we find that both local and global network topology information can help MIXP approach to improve classification accuracy. The order generated by ACOR algorithm provides the most help for sample classifications, a finding that implies the ACOR algorithm can group functionally related genes together in an ordered way.

The following references were used in the development of the present invention, and the disclosures of which are explicitly incorporated by reference herein:
1. Chen, J. Y., S. Mamidipalli, and T. Huan, HAPPI: an online database of comprehensive human annotated and predicted protein interactions. BMC Genomics, 2009. 10 Suppl 1: p. S16.
2. Chen, J. Y., C. Shen, and A. Y. Sivachenko, Mining Alzheimer disease relevant proteins from integrated protein interactome data. Pacific Symposium on Biocomputing Pacific Symposium on Biocomputing, 2006: p. 367-78.
3. Dorigo, M., E. Bonabeau, and G. Theraulaz, Ant algorithms and stigmergy. FUTURE GENER COMPUT SYST, 2000. 16(8): p. 851-871.
4. Kohler, S., et al., Walking the interactome for prioritization of candidate disease genes. The American Journal of Human Genetics, 2008. 82(4): p. 949-958.
5. Enright, A. J., S. Van Dongen, and C. A. Ouzounis, An efficient algorithm for large-scale detection of protein families. Nucleic Acids Research, 2002. 30(7): p. 1575-1584.
6. Nabieva, E., et al., Whole-proteome prediction of protein function via graph-theoretic analysis of interaction maps. Bioinformatics, 2005. 21(1): p. i302-i310.
7. Chua, H. N., W. K. Sung, and L. Wong, Exploiting indirect neighbours and topological weight to predict protein function from protein-protein interactions. Bioinformatics, 2006. 22(13): p. 1623-1630.
8. Wu, X., et al., Finding fractal patterns in molecular interaction networks: a case study in Alzheimer's disease. International Journal of Computational Biology and Drug Design, 2009. 2(4): p. 340-352.
9. Wu, X., R. Pandey, and J. Y. Chen, Network topological reordering revealing systemic patterns in yeast protein interaction networks. IEEE Engineering in Medicine and Biology Society, 2009. 1: p. 6954-6957
10. Morrison, J. L., et al., GeneRank: using search engine technology for the analysis of microarray experiments. BMC bioinformatics, 2005. 6(1): p. 233.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A method of creating a database for identifying the occurrence of a particular personal health situation, said method comprising:
identifying a plurality of related targets relating to a particular personal health situation;
creating a network of said related targets wherein one of said related targets is expanded to include neighboring targets;
organizing the nodes according to an iterative weighing so that nodes with similar reactivity with the particular personal health situation are grouped within the network and trace responses are aggregated according to network proximity to identify relevant targets to the particular disease; and
storing the plurality of related targets in a data set model on a memory device.

2. The method of claim 1 wherein the particular health situation involves a disease.

3. The method of claim 1 wherein the particular health situation involves a condition.

4. The method of claim 1 wherein the step of identifying includes identifying genes related to the particular health situation.

5. The method of claim 1 wherein the creating step includes expanding a plurality of related targets, and after expanded the plurality of related targets are combined.

6. The method of claim 1 wherein said organizing step involves using a flow simulation algorithm in the iterative weighing.

7. The method of claim 1 wherein said organizing step involves using an ant colony optimization algorithm in the iterative weighing.

8. The method of claim 1 further including the step of obtaining a gene-expression profile from a particular patient, wherein said organizing step involves mapping the gene-expression profile from the particular patient onto organized nodes.

9. A method of identifying the propensity of a particular personal health situation for a particular patient, said method comprising:
obtaining a sample from a patient;
creating a gene expression profile for the patient based on said sample;
comparing the results of said sample with a database relating to the particular disease, wherein the database was created according to the method of claim 1.

10. The method of claim 9 wherein the comparing step uses a database created according to the method of claim 2.

11. The method of claim 9 wherein the comparing step uses a database created according to the method of claim 3.

12. The method of claim 9 wherein the comparing step uses a database created according to the method of claim 4.

13. The method of claim 9 wherein the comparing step uses a database created according to the method of claim 5.

14. The method of claim 9 wherein the comparing step uses a database created according to the method of claim 6.

15. The method of claim 9 wherein the comparing step uses a database created according to the method of claim 7.

16. A system for determining the propensity of a particular personal health situation for a particular patient, said system comprising:
a patient profile module configured to generate a gene-expression profile from a sample from the particular patient;
a mapping module configured to map the gene-expression profile onto a database created according to the method of claim 1 for the particular personal health situation; and
a calculation module configured to integrate influence functions of the gene-expression profile and provide an indication of the particular personal health situation propensity of the particular patient.

17. The system of claim 16 wherein said mapping module uses a database created according to the method of claim 4.

18. The system of claim 16 wherein said mapping module uses a database created according to the method of claim 5.

19. The system of claim 16 wherein said mapping module uses a database created according to the method of claim 6.

20. The system of claim 17 wherein said mapping module uses a database created according to the method of claim 7.
